(19) United States
(12) Patent Application Publication
(10) Pub. No.: US 2013/0127181 A1
(43) Pub. Date: May 23, 2013

(54) PUSH-PULL CLOSING DEVICE

(71) Applicant: Stefano Rocchitelli, Nerviano (Milano) (IT)

(72) Inventor: Onofrio Rocchitelli, Nerviano (Milano) (IT)

(21) Appl. No.: 13/642,277

(22) PCT Filed: Apr. 18, 2011
(86) PCT No.: PCT/IT11/00120

§ 371 Date: Feb. 1, 2013

(30) Foreign Application Priority Data
Apr. 21, 2010 (IT) MI2010A000676

(51) Int. Cl. E05C 1/08

(52) U.S. Cl. CPC E05C 1/08
USPC 292/182

(57) ABSTRACT

The invention regards a locking device for the closing door of a washing and drying machine, constituted of a body of containment that houses a locking wheel for the door latch, subject to the action of elastic means, a sliding bolt capable of preventing the rotation of said wheel and a time-delay mechanism fitted with a locking pawl for said sliding bolt. The wheel is fitted with a cavity that presents a surface tilted with respect to the plane of rotation, so as to resolve the force it exerts on the bolt, when a pulling is exerted on the door while the device is in a closed and locked position.

The present invention regards a device for the closing of the door of domestic appliances, in particular of washing machines. The invention will in the following be described with reference to such a type of appliance, without this being intended in a limited sense.

The door closing the washing machine's charging space is fitted with a latch capable of engaging a locking device mounted on the panel of the machine.

The locking devices of the machines equipped with drums of a particular size, such as in drying machines, must, for safety reasons, allow the opening of the door even from the inside of the machine, by simply exerting a pressure of a pre-established intensity.

In order to observe the safety rules, the locking devices employed in this domain moreover comprise a time-delaying device of an electromagnetic or thermal type, commonly known as a door lock, which prevents the opening of the door after the startup of the machine and delays the opening of the door at the end of the operating cycle or at the occurrence of certain conditions. Locking devices of a “push-pull” type are known, which allow effecting the closing of the door by simply exerting a pressing action, and its opening by applying a relatively modest pulling force. Such devices are thus allowing the opening of the door to be realized even from inside the machine.

A known locking device of this type is constituted of an oscillating wheel capable of constraining the extremity of the door's closing latch, and of a sliding bolt translating in a direction perpendicular to the plane of rotation of the wheel.

The wheel assumes a releasing position and a retaining position of the latch based on the action of elastic means of a compressing type, while the sliding bolts prevents a rotation until certain conditions occur.

A drawback of some already known devices derives from the fact that they are not always capable of realizing a proper sealing of the door. If a pulling force of particular intensity were to be exercised on the door, its opening could in fact occur even during the machine's operation, thus under conditions when the sliding bolt, being constrained by the pawl of the door locking device, should guarantee its closing.

The known devices that allow guaranteeing a proper seal in a locking phase have the drawback of being constructed with certain kinematic devices of considerable size or made of expensive materials.

The purpose of the present invention is to overcome the drawbacks and limitations of the previous art, by a new and improved kinematic device that allows reducing the size of the closing device so that the same can be easily applied even to washing machines already present on the market, without requiring structural modifications, and a production with materials similar to those currently employed.

The innovation achieves these purposes through a locking device for the door of washing machines or the like, of a push-pull type according to claim 1. Additional advantageous characteristics are the object of subordinate claims.

The invention will now be described with reference to the enclosed drawings, which illustrate a preferred yet not limiting form of embodiment of the invention, where:

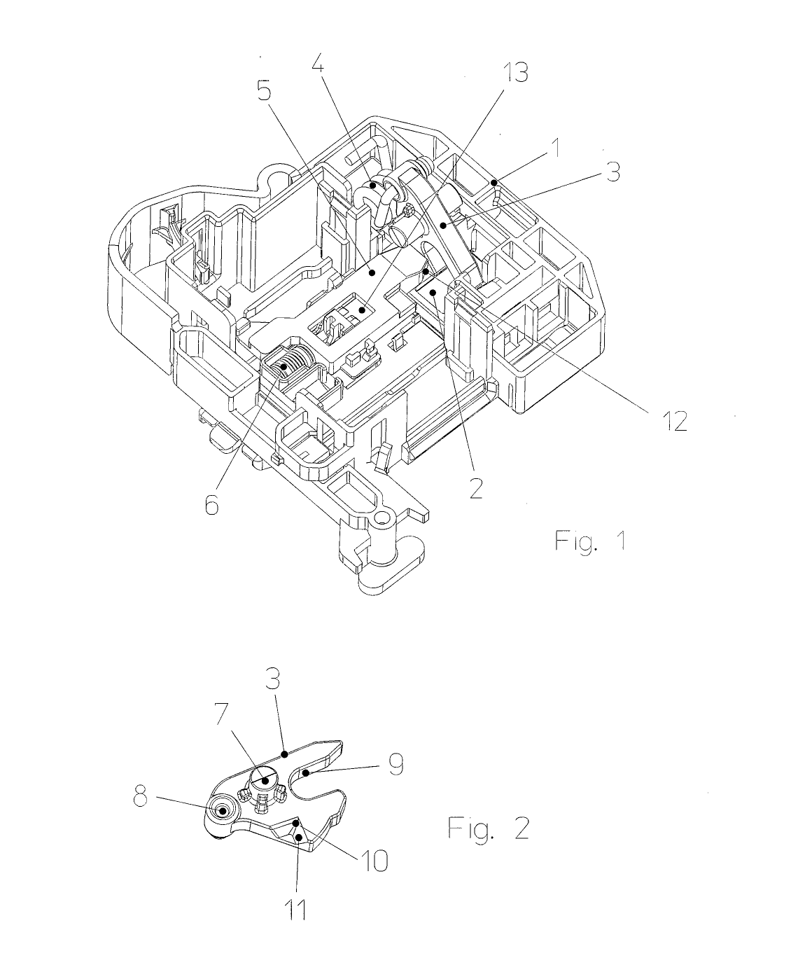

FIG. 1 is an axonometric view of the closing device according to the invention,

FIG. 2 shows the locking wheel of the device of FIG. 1.

With reference to the figures, the closing device according to the invention is constituted of a containment body 1, preferably made of a thermoplastic material and equipped with means fastening it to the panel of the machine. A rectangular opening 2 is carved out in the body 1 and fitted, in a known manner, with a projecting frame not evidenced in the figure. When the device is installed, the opening 2 is disposed opposite to the inlet hole of the door latch, provided on the panel of the machine, and the projecting frame serves the function of inviting the latch as well as an esthetic finish. The body 1 houses a locking wheel 3 subject to the action of a torsion spring 4 and a sliding bolt 5 subject to the action of a helical spring 6.

An electromagnetic or thermal time-delay mechanism of a known type (not evidenced in the figure) is housed in the body 1 opposite the bolt 5, and equipped with a locking pawl that is actuated by a system connected to the machine's operating controls. At a point opposite to the time-delay mechanism, the bolt 5 presents a seat 13 capable of receiving the locking pawl.

The wheel 3 is constrained in a hinge-like manner to the body 1, through a pin 7. It has a cavity 9 suitable for receiving the extremity of the door latch and is, in a diametrically opposite position, fitted with a seat 8 designed to house the extremities of the torsion spring 4.

The locking wheel 3 may, under the action exerted by the spring 4, assume two positions of a stable equilibrium, meaning a resting position as shown in FIG. 1, where the cavity 9 is axially disposed with respect to the opening 2, and a position of retaining the door latch, in which the wheel closes the opening 2, thus preventing an extraction of the latch. The wheel 3 has, at a point opposite to the portion interacting with the sliding bolt 5, a cavity 10 shaped so as to present a flat surface 11 tilted with respect to the plane of rotation.

The contoured extremity of the sliding bolt 5, which cooperates with the wheel 3, presents a flat face orthogonal to the direction of translation, and a face 12 oblique with respect to said direction and appropriately tilted to interact with the surface 11 of the wheel 3.

The slant of the surface 11 is determined so as to resolve the force that is exerted by the wheel 3 on the sliding bolt 5 while pulling the door, into two components. The first component is applied to the bolt 5 in a direction oblique with respect to the direction of translation and opposed by the constraining reaction exerted by the body 1; the second component, of a lesser value than the first, works in the direction of translating the bolt, and is opposed by the locking pawl of the time-delay mechanism.

The operation of the device occurs in the following manner.

When the door is in an open position, the mechanical components are in their respective positions shown in FIG. 1.

In particular, the wheel 3 in a resting position prevents a translation of the cursor 5, which in turn inhibits the action of the door locking pawl and the consequent startup of the machine.

When the door is closed, the latch is inserted into the opening 2 and acts on the locking wheel 3, thus inducing its rotation.

At the same time, the cursor 5 translates and the contoured extremity taps into the cavity 10, thus establishing the contact between the surfaces 12 and 11.

When the door is closed yet still unlocked, meaning before actuating the door locking pawl, the wheel 3 can be driven to rotate against the elastic means 4, thus causing the sliding bolt 5 to withdraw and the door to open even from the inside of the machine, while exerting a pressing action on the door. When operating the machine, the pawl of the door locking device taps into the seat 13 in a position locking the cursor 5 and thereby the wheel 3. Even if applying a pulling action on the door, it is under these conditions impossible to cause an opening, because the rotation of the locking wheel 3 is inhibited by the cursor 5, which is in turn constrained by the pawl of the door locking device.

Even in case a pulling force of particular intensity is exerted on the door, the device is capable of preventing its opening, because the force exerted by the wheel 3 on the cursor 5 is resolved into two components and need therefore not be opposed by the locking pawl alone. A prime component is in fact, through the surface 11, acting on the sliding bolt 5, which is in turn constrained by the body 1 in a transversal direction, and a lesser component acts in the translating direction of the bolt 5 and can be properly opposed by the locking pawl of the time-delay mechanism.

At the end of the operating cycle, the locking pawl withdraws in a known manner while releasing the cursor 5, thus allowing the rotation of the wheel 3 and the extraction of the latch from the door. The elements of the device return to their respective positions as shown in FIG. 1.

The invention has been illustrated with reference to a preferred construction, but it is generally susceptible of other applications and modifications, all meant to be comprised in the range of protection, as will be evident to a specialist in the branch.

1. A locking device for the door of household appliances, comprising a body of containment that houses a door latch locking wheel subject to the action of elastic means, a sliding bolt capable of preventing the rotation of said wheel and a time-delay mechanism to actuate a locking pawl for said sliding bolt, characterized by the fact that the wheel is fitted with a cavity that presents a surface tilted with respect to the plane of rotation, so as to interact with the contoured extremity of the sliding bolt, which is likewise tilted so as to resolve the force exerted by the wheel on the sliding bolt while pulling the door, into two components, one working in the direction of translating the sliding bolt, which is capable of causing the sliding bolt to withdraw and therefore the opening of the door from the inside of the household appliance when the door is closed before actuating the door locking pawl.

2. The locking device according to claim 1, characterized by the fact that the wheel is hinge-tied to the body through a pin.

3. The locking device according to claim 1, characterized by the fact that the wheel is subject to the action of a torsion spring.

4. The locking device according to claim 1, characterized by the fact that the extremity of the sliding bolt interacting with the wheel is contoured so as to present a flat face orthogonal to the direction of sliding.
